(19) United States
(12) Patent Application Publication
(10) Pub. No.: US 2007/0100704 A1
(43) Pub. Date: May 3, 2007

(54) Shopping assistant

(75) Inventors: Zicheng Liu, Bellevue, WA (US); Silviu-Petru Cucerzan, Redmond, WA (US); Zhengyou Zhang, Bellevue, WA (US); David J. Kurlander, Seattle, WA (US); Alejandro Acero, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/261,220

(22) Filed: Oct. 28, 2005

(51) Int. Cl. G06Q 30/00

(52) U.S. Cl. 705/26

(57) ABSTRACT

A multi-modal device that can substantially facilitate intelligent shopping. Electronic receipts can be provided to a user wirelessly and stored/indexed on the multi-modal device. Receipts can be categorized (e.g., personal, business, client entertainment) thereby facilitating financial management and accounting. Likewise, such electronic receipts can provide for easier return/exchange of goods. The multi-modal device can also assist in tracking/managing shopping lists and business cards (e.g., provide for business card exchanges). Moreover, the multi-modal device can provide for comparison shopping, catalog shopping, locating products and obtaining more information about a product via visual or audio mechanisms.

### BACKGROUND

Both enterprises and individuals are increasingly interested in using handheld devices. Most modern handheld devices are equipped with multiple sensors (e.g., microphone, wireless transmitter, global positioning system (GPS) engine, camera, stylus, etc.). However, there are no applications available that make full use of multiple sensors. In other words, multi-sensory technologies that make handheld devices a multi-modal multi-lingual mobile assistant are not available.

Today, cellular telephones running on state-of-the-art operating systems have increased computing power in hardware and increased features in software in relation to earlier technologies. For instance, cellular telephones are often equipped with built-in digital image capture devices (e.g., cameras) and microphones together with computing functionalities of personal digital assistants (PDAs). Since these devices combine the functionality of cellular phones with the functionality of PDAs, they are commonly referred to as “smart-phones.”

The hardware and software features available in these smart-phones and similar technologically capable devices provide developers the capability and flexibility to build applications through a versatile platform. The increasing market penetration of these portable devices (e.g., PDAs) inspires programmers to build applications, Internet browsers, etc. for these smart-phones.

The Internet continues to make available ever-increasing amounts of information which can be stored in databases and accessed therefrom. For example, product information can readably be accessed via the Internet to assist a consumer in researching a prospective purchase. For example, a user or consumer can research information such as pricing, performance/quality ratings, availability, etc. via the Internet with respect to a desired product.

Additionally, with the proliferation of portable terminals (e.g., notebook computers, cellular telephones, PDAs, smart-phones and other similar communication devices), users are becoming more mobile, and hence, trackable with respect to buying habits and locations that they tend to frequent. For example, many devices are being designed with a geographic location tracking technology such as GPS for reasons of safety, finding travel destinations, etc. Thus, it now becomes possible to determine the current location of the user. This location information can be valuable to providing an intelligent shopping experience.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a system that facilitates intelligent shopping. In a particular aspect, the system can facilitate tracking purchases by automatically categorizing the purchases into buckets or categories. This categorization can particularly assist in financial management and/or accounting of purchases and/or expenses. In one aspect, the categorization can assist in preparation of an expense report for the corporate and/or business professional. As such, personal expenses can be automatically distinguished from business and entertainment expenses.

In still another aspect, an electronic receipt can be provided to a user wirelessly and stored/indexed on a multi-modal portable device. As described above, these receipts can be categorized (e.g., personal, business, client entertainment). Likewise, in another scenario, such electronic receipts can provide for easier return/exchange of goods.

In still other aspects, the novel functionality of the system can facilitate managing shopping lists. For example, a user can employ an integrated image capture mechanism (e.g., camera, scanner) to capture business cards. Likewise, an aspect facilitates sharing business cards and information therefrom.

In yet another aspect, the system facilitates comparison shopping via a multi-modal portable device. For example, a user can snap a picture and find like items by accessing internal and/or external data sources. Other aspects of portable device-assisted intelligent shopping mechanisms include catalog shopping and obtaining more information about a product via visual or audio mechanisms.

In still another aspect, the system can facilitate receiving location based prompts within a store or facility regarding items that may be of interest (e.g., based upon trends, buying habits) and that are proximally located. Location detection systems (e.g., global positioning system) can be employed to determine a reference and/or target location. These aspects can particularly assist a user/consumer to a location of a desired product via a multi-modal portable device.

In yet another aspect, the system can communicate with store/facility systems to download store-based information such as electronic weekly circulars and promotions. The system would then allow the user to mark desired products and, upon approaching the aisle where such products are shelved, alert the user. In one exemplary scenario, a grocery store can communicate a recipe of the week to the device. In accordance therewith, the recipe may use some on-sale products. The novel system described herein can guide the user/consumer to the aisles where the necessary ingredients are stored. In another scenario, the user can have the recipes downloaded from another source (e.g., Internet, home server. . . ).

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a system that facilitates tracking transactions in accordance with an aspect of the intelligent shopping assistant.

FIG. 2 illustrates an exemplary flow chart of procedures that facilitate categorizing expenses and/or purchases in accordance with an aspect of the subject matter.

FIG. 3 illustrates a block diagram of a system that employs a transaction management component that includes a receiving component and an indexing component in accordance with an aspect of the innovation.

FIG. 4 illustrates a general block diagram of a product analysis component in accordance with an aspect of the novel subject matter.

FIG. 5 illustrates a specific block diagram of a product analysis component in accordance with an aspect of the innovation.

FIG. 6 illustrates an exemplary flow chart of procedures that facilitate utilizing an image capture device to initiate research of a product in accordance with an aspect of the shopping assistant.

FIG. 7 illustrates an exemplary flow chart of procedures that facilitate utilizing an audio capture device to initiate research of a product in accordance with an aspect of the innovation.

FIG. 8 illustrates a block diagram of a multi-modal portable device that facilitates intelligent shopping in accordance with an aspect of the novel functionality of the innovation.

FIG. 9 illustrates an architecture of a multi-modal portable communication device that facilitates automating an action in accordance with an aspect.

FIG. 10 illustrates an architecture of a portable handheld device including an artificial intelligence reasoning component that can automate functionality in accordance with an aspect of the invention.

FIG. 11 illustrates an architecture of a portable handheld device including a rules-based logic component that can automate functionality in accordance with an aspect of the invention.

FIG. 12 illustrates a block diagram of a computer operable to execute the disclosed architecture.

FIG. 13 illustrates a schematic block diagram of an exemplary computing environment in accordance with the subject invention.

### DETAILED DESCRIPTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

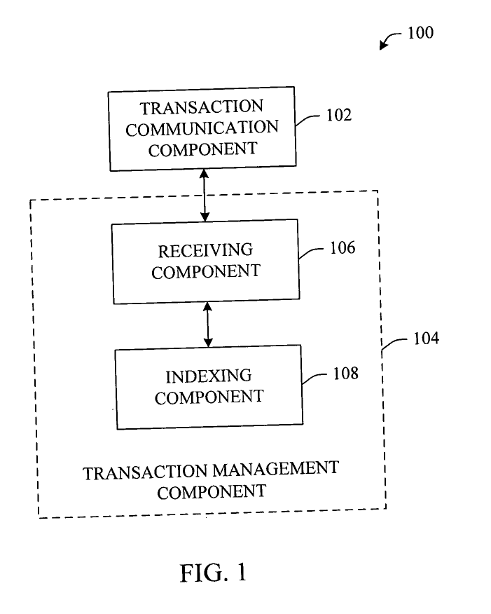

Referring initially to the drawings, FIG. 1 illustrates a system 100 that facilitates intelligent shopping in accordance with an aspect of the claimed subject matter. Generally, system 100 can include a transaction communication component 102 and a transaction management component 104. It is to be understood and appreciated that any wired and/or wireless protocol can be employed to facilitate communication between the components of system 100. It is also to be understood that any wired and/or wireless protocol can be employed to facilitate communication and data transmission between the components of the figures that follow.

In operation, the transaction communication component 102 can transfer consumer-specific transaction information to the transaction management component 104. By way of a more detailed example, the transaction communication component 104 can facilitate transaction information such as electronic purchase receipts and the like to the transaction management component 104. In accordance therewith, the transaction management component 104 can maintain consumer purchasing information which can be employed for a number of purposes including, but not limited to, establishment of buying trends, categorization of expenses, establishment of financial portfolio information, product research or the like. These and other scenarios will be described in greater detail infra.

As illustrated, in one example, the transaction management component 104 can include a receiving component 106 and an indexing component 108. The receiving component 106 can fetch and/or receive data and information from the transaction communication component 102. In turn, and in accordance with the illustrated aspect of FIG. 1, the indexing component 108 can be employed to index and/or categorize the information. For example, the information can contain purchase receipt information that can be categorized into expense categories such as personal, business, entertainment, home improvement, or the like. As such, financial planning and tracking can particularly be streamlined with this novel and automatic indexing feature.

In another exemplary aspect of the claimed subject matter, the information can be transmitted to and/or stored in separate data stores in accordance with a respective product classification and/or type. It is to be understood and appreciated that the disparate data stores can be local and/or remote from the indexing component 108. In one particular example, the indexing component 108 can facilitate transferring and storing business expense information in a disparate location and/or store with personal information manager (PIM) data thus streamlining a reporting of business and/or travel expenses.

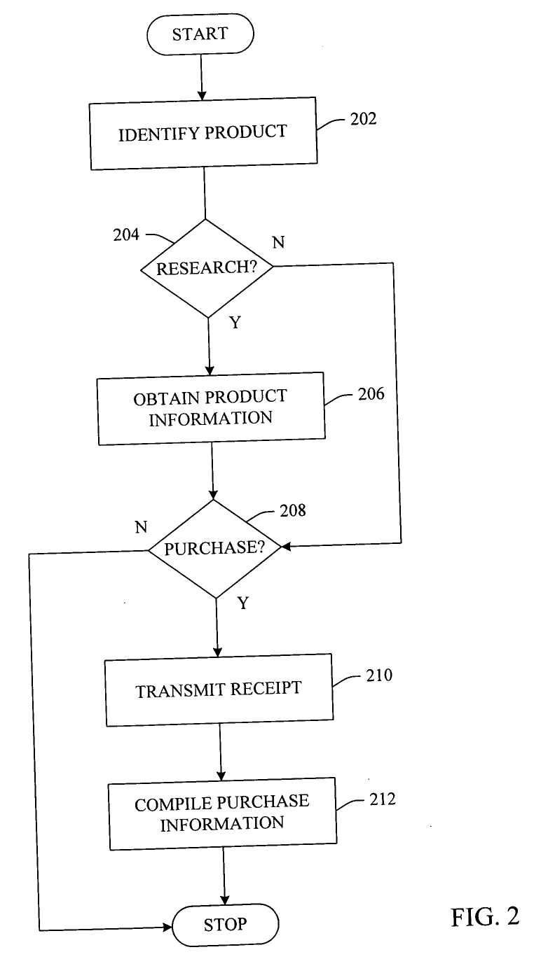

FIG. 2 illustrates a methodology of researching and tracking a purchase of a product in accordance with an aspect of the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 202, a specific product is identified. Although the aspects described herein are directed to the purchase and/or tracking of specific products, it is to be appreciated that the novel functionality described herein can be directed to any service and/or group of products. In a particular aspect, at 202, a product can be directly identified by a consumer. Additionally, in other aspects, sensors such as image and audio capture sensors (e.g., camera, scanner, microphone) can be employed to facilitate identification of a product. Still other aspects can infer a user action and/or preference thereby automatically prompting identification of a product. This inference can be accomplished via the use machine learning mechanisms (e.g., artificial intelligence (AI)) and/or rules-based logic based at least in part upon an established context.

Once a product is identified at 202, a determination is made if research is necessary and/or desired at 204. If research is necessary and/or desired, product information is obtained at 206. In one aspect, it is to be understood and/or appreciated that product information can be obtained via the Internet or other local and/or external information source. Product information can include, but is not limited to include, pricing, availability, vendor name(s), vendor location(s), performance/quality ratings or the like.

However, if at 204, research is not desired, at 208, a determination is made if a purchase has been consummated. If consummated, an electronic acknowledgment (e.g., receipt) can be transmitted at 210. It is to be understood and appreciated that the purchase acknowledgement can be transmitted to any desired location or group of locations. Accordingly, at 212, the information can be indexed in any desired manner.

As described above, in one example, the information can be indexed into personal, business and/or entertainment categories thus facilitating easier tracking and reconciliation of expenditures. Moreover, these indexed expenditures can be imported directly into tracking and/or financial applications thereby facilitating even more efficient accounting. In yet another aspect, the information can be stored directly into a PIM data store thus enabling this information to be available to other PIM applications. It will be understood that the information can be stored in any data store in any location thereby enhancing data availability. For instance, this receipt information can be easily accessed thus providing availability for return/exchange of goods.

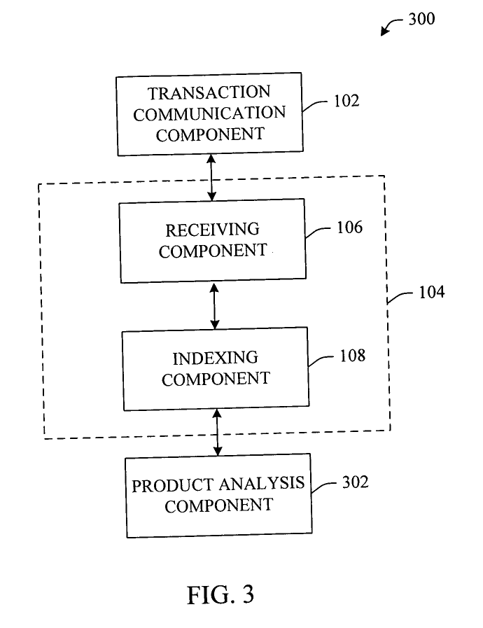

Referring now to FIG. 3, there is illustrated a system 300 that facilitates researching a product (or service) in accordance with an aspect of the claimed subject matter. Generally, system 300 can include a transaction communication component 102, a transaction management component 104 and a product analysis component 302. As described supra with reference to FIG. 1, the transaction communication component 102 and the transaction management component 104 can be employed to track purchases. As well, these components (102, 104) can be employed to index (e.g., categorize) purchases.

The product analysis component 302 can be employed to facilitate comparison shopping, for example, by snapping a photograph of a product and locating like items. The product analysis component 302 can also facilitate obtaining more information about a particular product. By way of example, the product analysis component 302 can be employed to obtain more information by rendering the information textually, visually and/or audibly via a portable multimedia device.

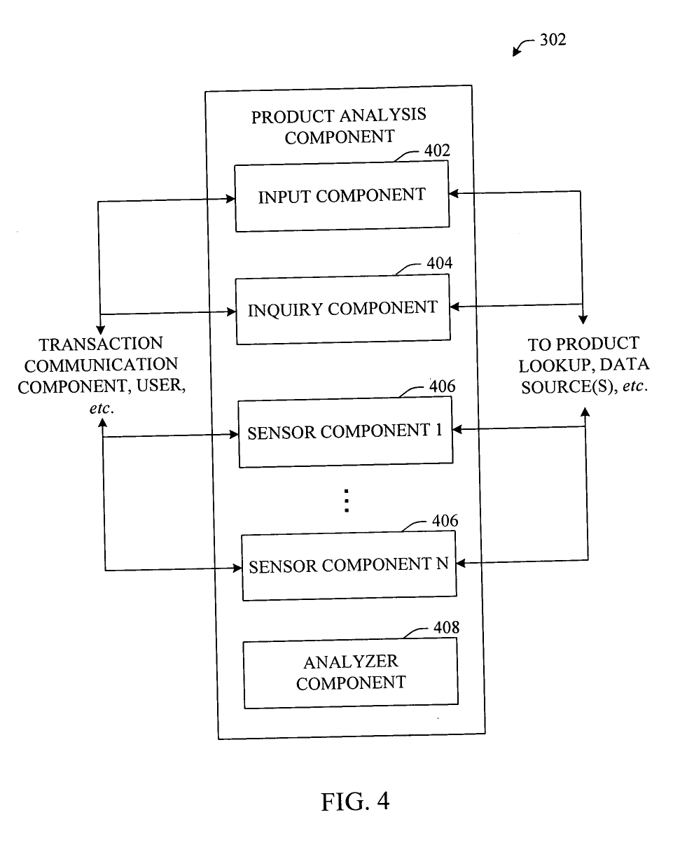

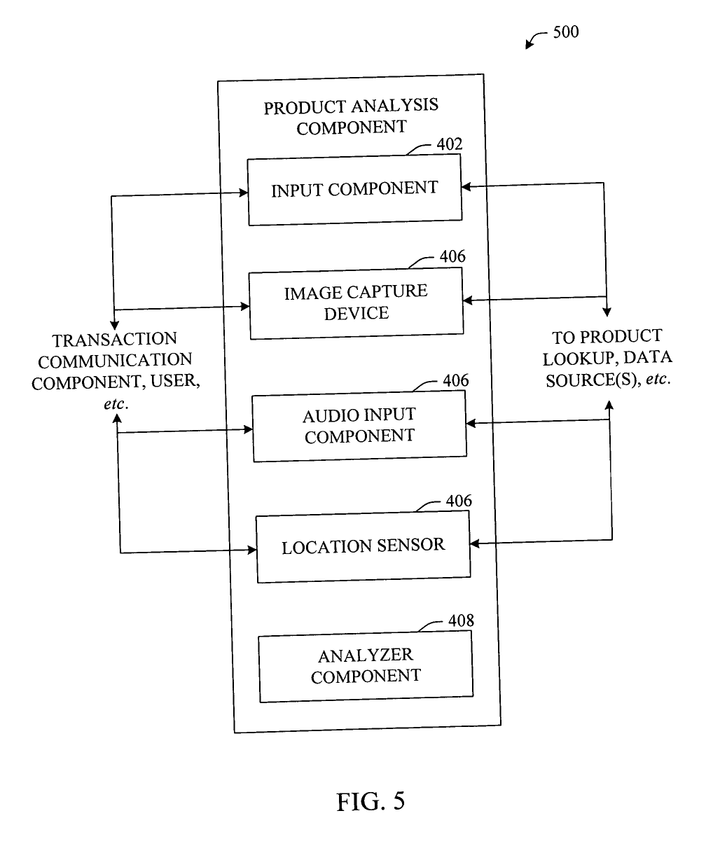

In still another aspect, the product analysis component 302 can receive and render location based prompts within a store or facility regarding items that may be of interest and that are proximally located. This alternative aspect will be better understood with reference to FIGS. 4 and 5 that follow.

Referring now to FIG. 4, a block diagram of a product analysis component 302 is shown. As illustrated, product analysis component 302 can include an input component 402, an inquiry component 404, 1 to N sensor components 406, where N is an integer, and an analyzer component 408. It should be understood that 1 to N sensor components can be referred to individually or collectively as sensor components 406. These sensor components 406 can be any available sensor known in the art. By way of example, these sensor components 406 can be employed for a variety of tasks such as detecting a current location, capturing an image of a product, recording a spoken product description, etc.

The product analysis component 302 can employ an analyzer component 408 to process product requests received and/or inferred from data made available from the input component 402, the inquiry component 404 and/or sensor components 406. Referring first to the input component 402, this component can enable a user to enter (e.g., via keyboard) a desired product or type of product. As well, data from the transaction communication component (102 of FIG. 1) can be entered into the product analysis component 302 via the input component 402. In operation, a user (e.g., consumer) can type the name of a desired product (e.g., television). Accordingly, the system can analyze the product type thereafter automatically communicating with internal and/or external (e.g., Internet) data sources to obtain and render product-specific information.

The inquiry component 404 can be employed to obtain information from a consumer with regard to a type of product desired. Continuing with the above example, if a user enters “television” into the input component 402, the inquiry component 404 can employ the analyzer component 408 to further inquire with regard to the product desired. For example, the system can inquire with regard to the type of “television” (e.g., conventional tube, liquid crystal display (LCD), plasma). In accordance therewith, the user can enter additional information via the input component 402 that can be utilized to enhance and/or streamline a search for product information (e.g., available vendors, price, ratings).

FIG. 5 illustrates a specific product analysis component 500 in accordance with an aspect of the novel subject matter. Generally, product analysis component 500 can be housed within a multi-modal communication device and can include sensor components 406 and an analyzer component 408. An input component 402 can be employed by a user to textually enter a product type and/or description thereafter prompting a product lookup.

Alternatively, in accordance with the aspect of FIG. 5, a user can utilize an image capture device (e.g., scanner, camera) to prompt a product lookup. For instance, a scanner component 406 can be employed to capture information in a visual format on a surface of a product packaging (e.g., bar code) thus prompting a product lookup. Similarly, a camera 406 can be employed to capture an image of a product.

Thereafter, the captured information (e.g., bar code pattern, photograph) can be communicated to the analyzer component 408, processed and interpreted. The analyzer component 408 can thereafter prompt a product lookup to obtain information with regard to the product or similar products. In one example, similar products can be located and rendered to a user via audio (e.g., speaker) or visual (e.g., display) mechanisms. It is to be understood that all information in accordance with the novel functionality described herein can be rendered in a variety of techniques (e.g., audio, video).

In yet another example, an audio input component 406 (e.g., microphone) can be employed to receive a spoken description of a product. Once received, the description can be analyzed (e.g., via analyzer component 408) thereafter prompting a product lookup. In still other aspects, an optional multi-language component (not shown) can be employed to translate the description into a language compatible with a present location or user. As well, a multi-language component (not shown) can be employed to translate product information into a language comprehendible to a user (e.g., based on a detected current location).

A location sensor 406 (e.g., global position system (GPS) can be employed to determine a present location of a user and/or portable communication device. For instance, the location sensor 406 can be employed to determine a location in relation to available vendors for a specific product. This location can be employed to determine vendors proximally located that sell a product as well as to determine a language/dialect and suitable translation.

In still another aspect, this location sensor 406 can be employed to receive location based prompts within a store or facility regarding items/products that may be of interest and that are proximally located. This inference can be based upon a number of factors including, but not limited to, buying habits, user state (e.g., ill), other related products purchased or in possession, etc. This inference can be accomplished via machine learning (AI) or other rule-based logic. These aspects will be described in greater detail infra.

In yet other aspects, the novel functionality of the system can facilitate managing shopping lists, coupons, business cards or the like. For example, the system can provide for business card exchanges. In accordance therewith, a user can employ an integrated image capture mechanism (e.g., camera, scanner) to capture business cards, interpret information contained thereon and, if desired, transmit the information to another device and/or location. With respect to shopping lists, the device can facilitate managing items on the lists, for example, automatically deleting obtained and/or purchased items. With respect to coupons, the system can automatically manage and/or transmit scanned and/or electronically received coupons thereafter prompting a user of the availability of a coupon. In accordance therewith, the system can prompt automatic transmission of an electronic coupon to a vendor register or tracking device.

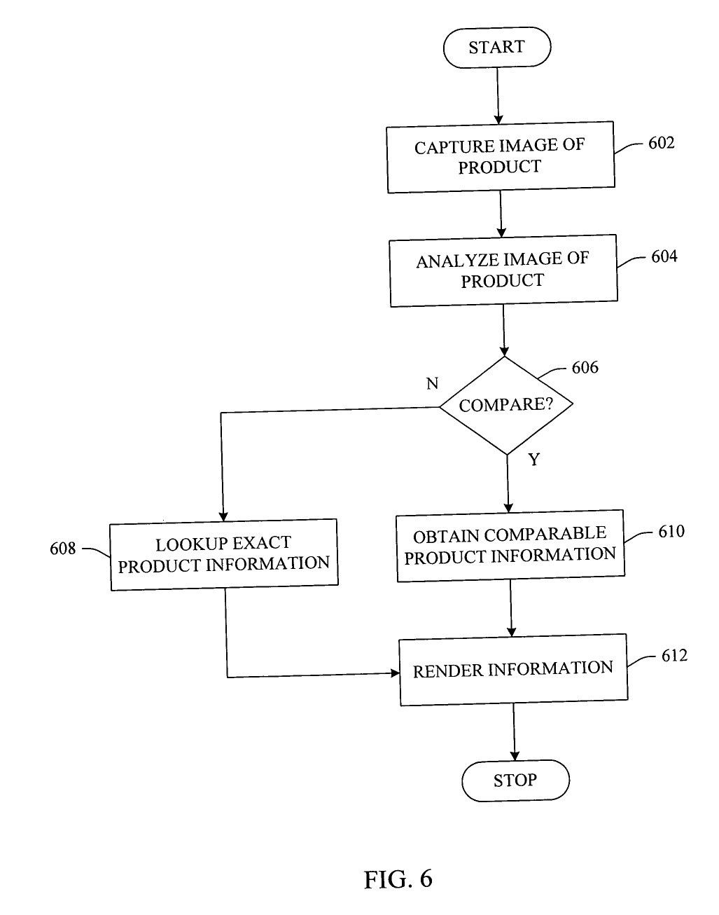

FIG. 6 illustrates a methodology of looking up a product in accordance with an aspect of the shopping assistant. At 602, an image of the product is captured. As described above, in one aspect, a scanner and/or camera can be employed to capture an image of a product or bar code. At 604, the image can be analyzed thereafter identifying the specific product.

A determination can be made at 606 if comparison shopping is to be commenced. If comparison shopping is not desired, at 608, product information can be retrieved that corresponds to the originally identified product. If at 606, comparison shopping is desired, at 610, comparable product information is obtained. In either instance, the information is rendered at 612. As described supra, the information can be rendered visually or audibly via a portable communications device.

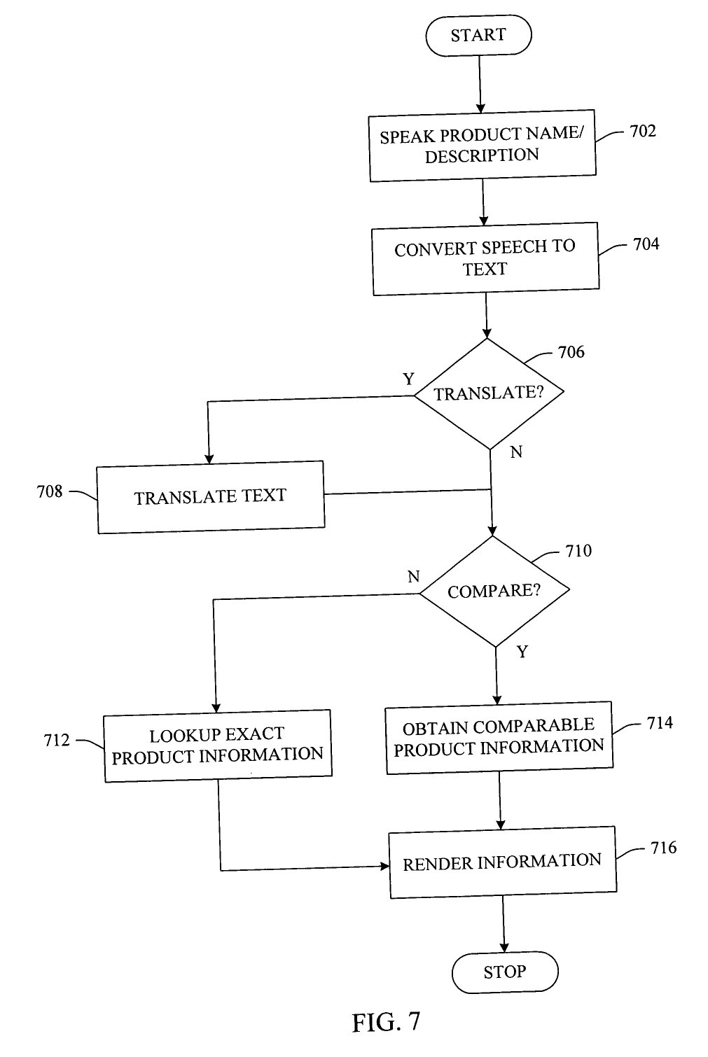

FIG. 7 illustrates a methodology of looking up a product in accordance with an aspect of the shopping assistant. Initially, at 702 a user (e.g., consumer) speaks a product name and/or description of a product. The speech that identifies and/or describes a product can be converted to text at 704. At 706, a determination is made if a translation is necessary. If, at 706, a determination is made that a translation is necessary, the translation is accomplished at 708. For example, a translation may be necessary in a foreign country in order to determine a location within a store or other facility. As described above, a location detection component (e.g., GPS) can be employed to assist in determining a language and/or dialect that corresponds with a current location.

Once the translation is complete at 708 or if it is determined that a translation is not necessary or desired, at 710, a determination can be made if comparison shopping is desired. If comparison shopping is not desired, at 712, product information can be retrieved that corresponds to the originally identified product. If at 710, comparison shopping is desired, at 714, comparable product information is obtained. It is to be understood and appreciated that comparable product information can be obtained from the Internet as well as any other local or external data source. Once product information is obtained, the information is rendered at 716. As described supra, the information can be rendered visually or audibly via a portable communications device.

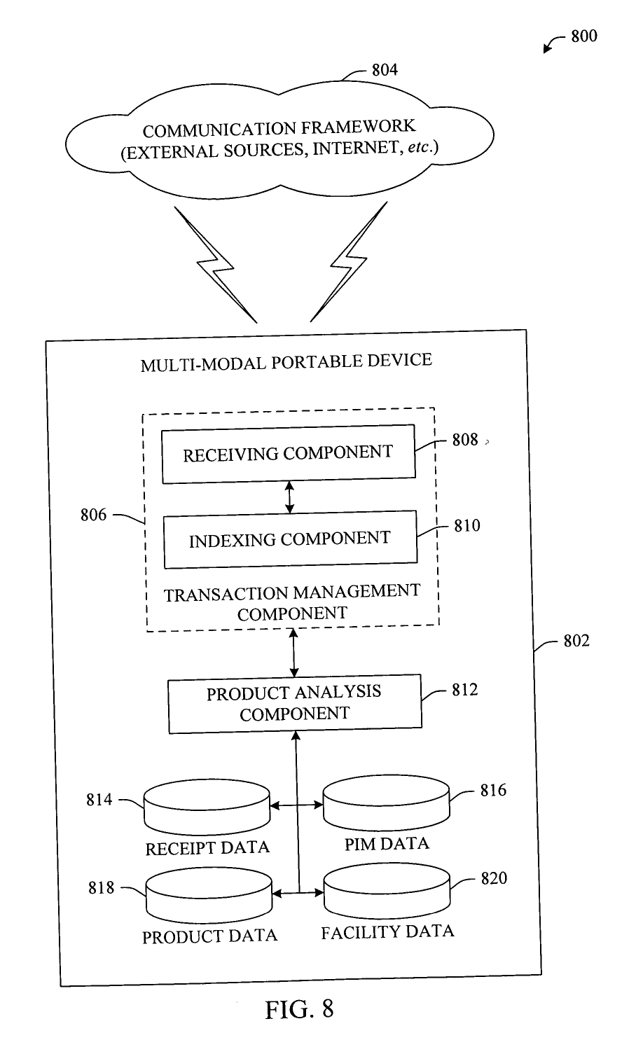

Turning now to FIG. 8, a block diagram of a system 800 that facilitates intelligent shopping in accordance with an aspect of the claimed subject matter is shown. Generally, the system 800 includes a multi-modal portable device 802 that is capable of accessing data from an external communication framework 804. The communication framework 804 can include the Internet, external server(s), wireless-enabled cash registers, as well as other external data sources.

Multi-modal portable device 802 can include a transaction management component 806 having a receiving component 808 and an indexing component 810 therein. A product analysis component 812 can also be provided to assist in researching product information (e.g., comparable products, price, location, vendor identification).

As described above, in one example, the receiving component 808 can obtain purchase acknowledgment information from a wireless cash register at the time of a purchase. Accordingly, the indexing component 810 can facilitate categorizing the receipt into a local and/or remote data store. More particularly, the indexing component 810 can facilitate storing the receipt and/or product information into a local receipt data store 814, a PIM data store 816, or external sources 804. As previously described, storing this information can particularly assist in managing financial information, evaluating buying trends, analyzing budgetary information, processing expense accounts, return/exchange of products, or the like.

The product analysis component 812 can facilitate access to product specific information. For example, the product analysis component 812 can be employed to render product information from local product data store 818, facility data store 820 as well as communication framework 804. More particularly, in one aspect, the subject shopping assistant (e.g., multi-modal portable device 802) can, via the product analysis component 812, render pricing information, rating information, facility location information, comparable product information, or the like. This intelligent shopping information can be rendered from local data stores (e.g., 818, 820) as well as external data sources (e.g., 804).

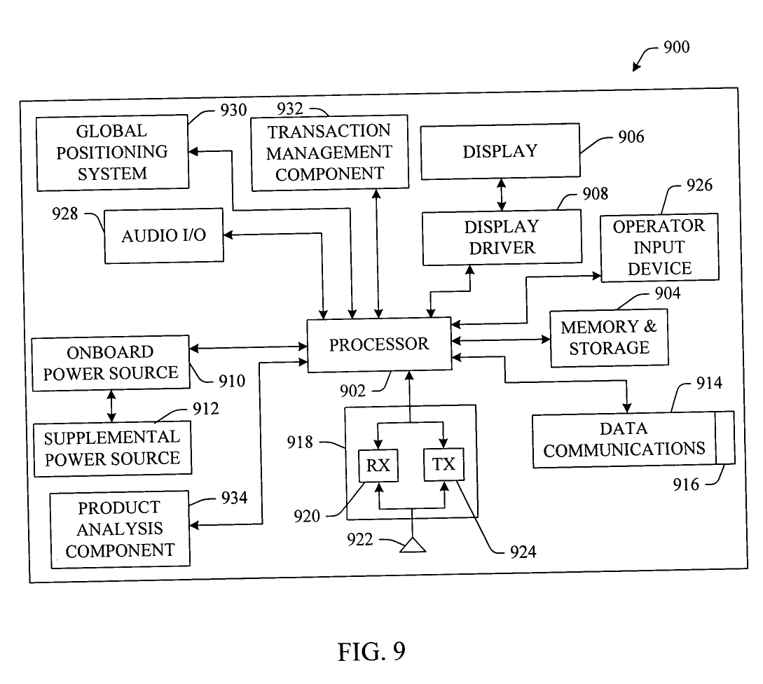

Referring now to FIG. 9, there is illustrated a schematic block diagram of a portable multi-modal multi-lingual hand-held device 900 according to one aspect of the subject invention, in which a processor 902 is responsible for controlling the general operation of the device 900. The processor 902 can be programmed to control and operate the various components within the device 900 in order to carry out the various novel analysis functions described herein. The processor 902 can be any of a plurality of suitable processors. The manner in which the processor 902 can be programmed to carry out the functions relating to the subject invention will be readily apparent to those having ordinary skill in the art based on the description provided herein.

A memory and storage component 904 connected to the processor 902 serves to store program code executed by the processor 902, and also serves as a storage means for storing information such as sensor inputs, PIM data, context data, user/device states or the like. The memory and storage component 904 can be a non-volatile memory suitably adapted to store at least a complete set of the information that is acquired. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information, and the processor 902 could include a program for alternating or cycling between various sets of gathered information.

A display 906 is coupled to the processor 902 via a display driver system 908. The display 906 can be a color liquid crystal display (LCD), plasma display, touch screen display, 3-dimensional (3D) display or the like. In one example, the display 906 is a touch screen display. The display 906 functions to present data, graphics, or other information content. Additionally, the display 906 can render a variety of functions that are user selectable and that control the execution of the device 900. For example, in a touch screen example, the display 906 can render touch selection icons that facilitate user interaction for product, vendor or other selective action.

Power can be provided to the processor 902 and other components forming the hand-held device 900 by an onboard power source 910 (e.g., a battery pack or fuel cell). In the event that the power source 910 fails or becomes disconnected from the device 900, a supplemental power source 912 can be employed to provide power to the processor 902 (and other components (e.g., sensors, image capture device, . . . )) and to charge the onboard power system 910, if a chargeable technology. In another example, in accordance with a determined context, supplemental power source 912 can be employed thereby conserving power in power source 910. In still another example, the alternative power source 912 can facilitate an interface to an external grid connection via a power converter (not shown) thereby obtaining power to operate or charge from the external grid if desired or deemed necessary.

The device 900 includes a communication subsystem 914 that includes a data communication port 916, which is employed to interface the processor 902 with a disparate multi-modal device, an external sensory mechanism(s), remote computer, server, service, or the like. The port 916 can include at least one of Universal Serial Bus (USB) and/or IEEE 1394 serial communications capabilities. Other technologies can also be included, but are not limited to, for example, infrared communication utilizing an infrared data port, Bluetooth™, Wi-Fi, Wi-Max, etc.

The device 900 can also include a radio frequency (RF) transceiver section 918 in operative communication with the processor 902. The RF section 918 includes an RF receiver 920, which receives RF signals from a remote device via an antenna 922 and can demodulate the signal to obtain digital information modulated therein. The RF section 918 also includes an RF transmitter 924 for transmitting information (e.g., data, services) to a remote device, for example, in response to manual user input via a user input (e.g., a keypad, voice activation) 926, or automatically in response to the completion of a location determination or other predetermined and programmed criteria.

The transceiver section 918 can facilitate communication with a transponder system, for example, either passive or active, that is in use with location-based data and/or service provider components. The processor 902 signals (or pulses) the remote transponder system via the transceiver 918, and detects the return signal in order to read the contents of the detected information. In one implementation, the RF section 918 further facilitates telephonic communications using the device 900. In furtherance thereof, an audio I/O subsystem 928 is provided and controlled by the processor 902 to process voice input from a microphone (or similar audio input device). The audio I/O subsystem 928 and audio output signals (from a speaker or similar audio output device). A translator component or multi-language component (not shown) can further be provided to enable multi-lingual/multi-language functionality of the device 900.

The device 900 can employ a global position engine 930 which can generate location context information. This location information can be employed by processor 902 with other contextual information (e.g., user state) to enhance intelligent shopping functionality as described in greater detail supra. More particularly, a transaction management component 932 and product analysis component 934 can be employed to further enhance intelligence and tracking functionality.

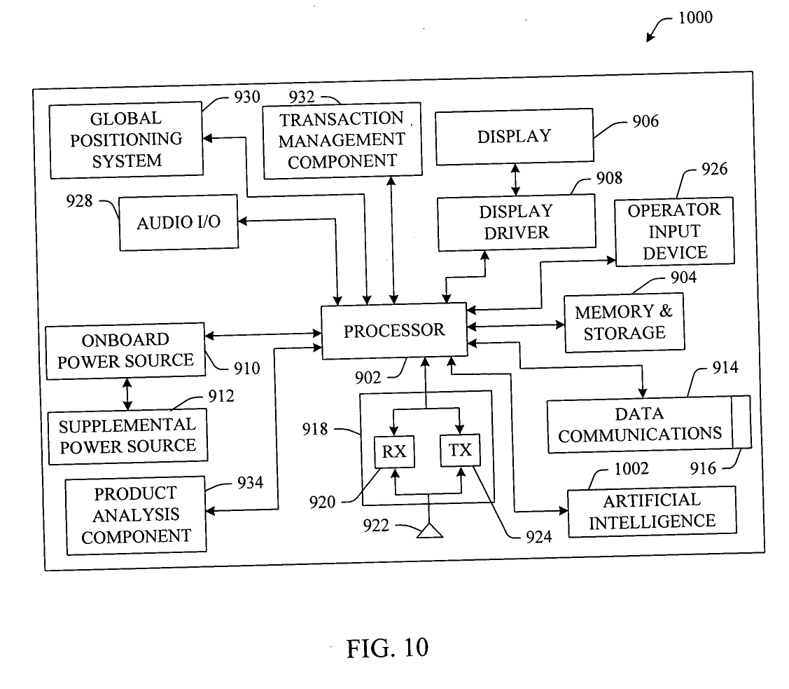

FIG. 10 illustrates a system 1000 that employs an AI component 1002 which facilitates automating one or more features in accordance with the subject invention. The subject invention (e.g., with respect to automatically selecting a product, inferring a preference, . . . ) can employ various AI-based schemes for carrying out various aspects thereof. For example, probabilistic and/or statistical-based analysis can be employed to effect inferring a user intention and/or preference with respect to a prospective purchase.

The subject innovation can employ various AI-based schemes for carrying out various aspects thereof. For example, a process for determining when/if to research or locate a product or a companion product can be facilitated via an automatic classifier system and process. Moreover, where electronic receipts are automatically received and indexed, the classifier can be employed to determine which categories to place specific items and how to allocate expenses.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when/if to select a product, when/if to research a product, how/if to index receipts, etc. The criteria can include, but is not limited to, the type of device(s), the location of the device, time of day/week/year, etc.

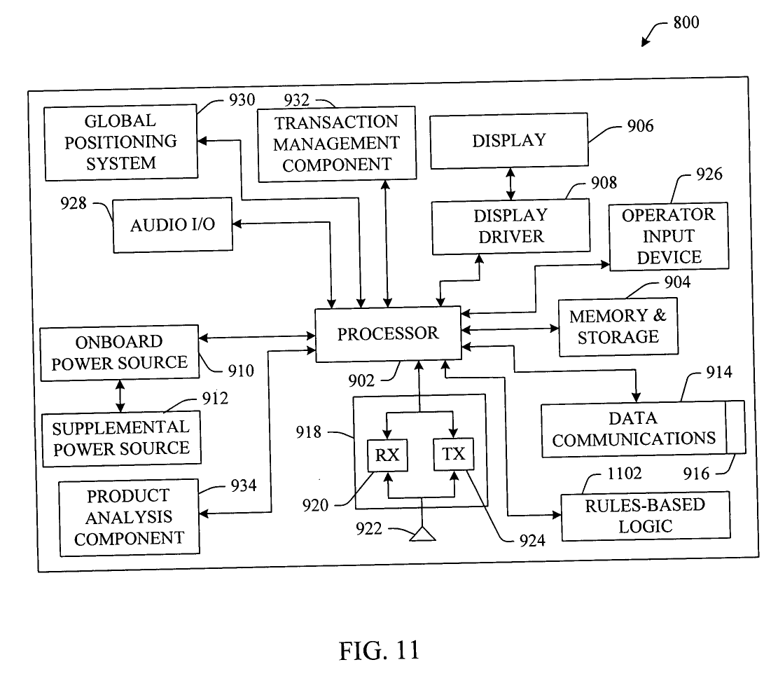

With reference now to FIG. 11, an alternate aspect of the invention is shown. More particularly, handheld device 1100 generally includes a rules-based logic component 1102. In accordance with this alternate aspect, an implementation scheme (e.g., rule) can be applied to define acceptable probabilities, determine products, perform research, etc.

By way of example, it will be appreciated that the rules-based implementation of FIG. 11 can automatically determine which products to select or when/if to research a product based upon a predetermined criteria. It is to be appreciated that any of the specifications and/or functionality utilized in accordance with the subject invention can be programmed into a rule-based implementation scheme. It is also to be appreciated that this rules-based logic can be employed in addition to, or in place of, the AI reasoning techniques described with reference to FIG. 10.

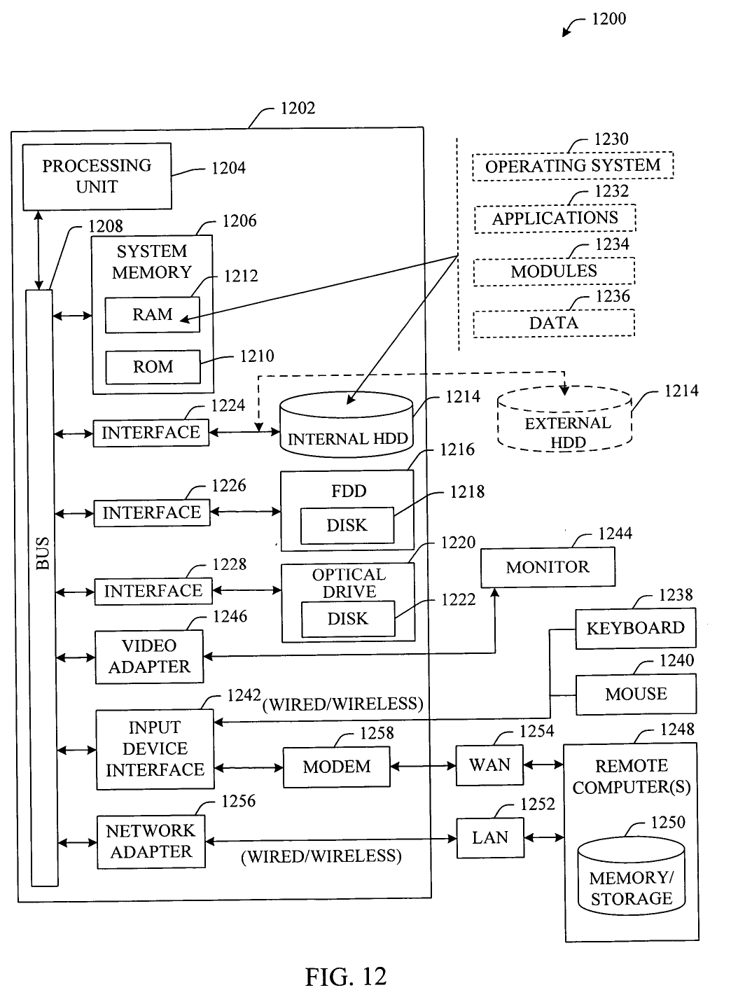

Referring now to FIG. 12, there is illustrated a block diagram of a computer operable to execute the disclosed architecture thereby facilitating intelligent shopping. In order to provide additional context for various aspects of the subject invention, FIG. 12 and the following discussion are intended to provide a brief, general description of a suitable computing environment 1200 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the invention includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the invention can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

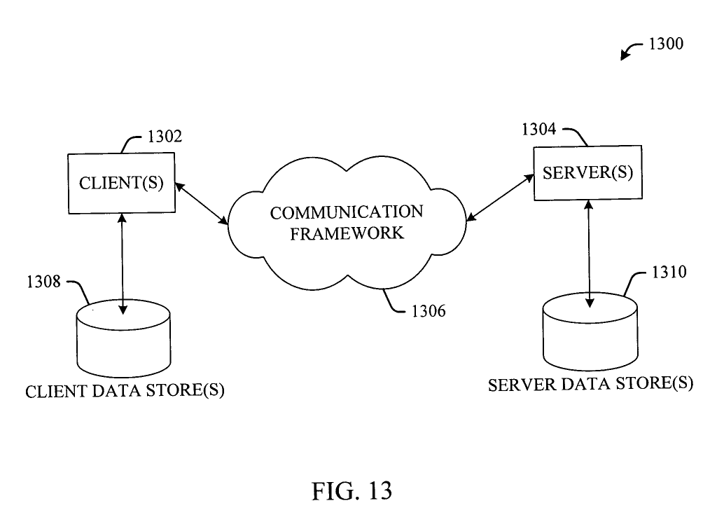

Referring now to FIG. 13, there is illustrated a schematic block diagram of an exemplary computing environment 1300 in accordance with the subject invention. The system 1300 includes one or more client(s) 1302. The client(s) 1302 can be hardware and/or software (e.g., threads, processes, computing devices). The client(s) 1302 can house cookie(s) and/or associated contextual information by employing the invention, for example.

The system 1300 also includes one or more server(s) 1304. The server(s) 1304 can also be hardware and/or software (e.g., threads, processes, computing devices). The servers 1304 can house threads to perform transformations by employing the invention, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates intelligent shopping, comprising:
a receiving component that electronically receives information that relates to a product and a vendor; and
a transaction management component that analyzes the information and advises a consumer based at least in part upon an outcome of the analysis.

2. The system of claim 1, the receiving component electronically receives an acknowledgment of a purchase associated to a consumer and the system further comprises an indexing component that indexes the acknowledgement into a catalog having a plurality of disparate acknowledgments that correspond to the user.

3. The system of claim 1, further comprising a transaction communication component that electronically transmits the acknowledgment of the purchase to the receiving component.

4. The system of claim 1, the indexing component categorizes the acknowledgement as at least one of a personal acknowledgment, a business acknowledgement and an entertainment acknowledgement.

5. The system of claim 1, further comprising a product analysis component that comprises a sensor that prompts comparison shopping based at least in part upon the product.

6. The system of claim 5, the sensor is an image capture device that captures an image of the product, the image capture device is at least one of a camera and a scanner.

7. The system of claim 6, the product analysis component analyzes the image and determines at least one of a product location, a product rating and a comparable product associated to the product.

8. The system of claim 5, the sensor is an audio input that receives speech related to a product and converts the speech into text related to the product.

9. The system of claim 8, the product analysis component employs the text and automatically obtains information related to the product.

10. The system of claim 9, the information is at least one of a location, a rating, a price list, and a comparable product.

11. The system of claim 10 further comprising a multi-language component that converts the audio input into a language comprehendible to the consumer.

12. The system of claim 1, further comprising an artificial intelligence (AI) component that employs a probabilistic and/or statistical-based analysis to infer an action that the consumer desires to be automatically performed.

13. A computer-implemented method of intelligent tracking of purchases, comprising:
receiving an electronic receipt that corresponds to a consumer purchase of a product; and
indexing the electronic receipt in a multi-modal portable device in a category based at least in part upon an inferred preference, the category is at least one of a personal, business and entertainment category.

14. The computer-implemented method of claim 13, further comprising dynamically maintaining a shopping list on the multi-modal portable device.

15. The computer-implemented method of claim 13, further comprising wirelessly obtaining information relating to the product.

16. The computer-implemented method of claim 15, the information is at least one of a store location, a product rating, a price and an alternative vendor source related to the product.

17. A system that facilitates intelligent shopping, comprising:
means for electronically identifying a product;
means for electronically determining a current location of a consumer; and
means for identifying a location of the product within a facility based at least in part upon the current location of the consumer.

18. The system of claim 17, the means for electronically identifying the product is an image capture device.

19. The system of claim 17, the means for electronically identifying the product is an audio recorder.

20. The system of claim 19, further comprising means for translating speech into a language comprehendible to the consumer.
